(19) United States
(12) Patent Application Publication
(10) Pub. No.: US 2014/0030927 A1
(43) Pub. Date: Jan. 30, 2014

(54) CARD EDGE CONNECTOR

(71) Applicant: SPEED TECH CORP., Taoyuan Hsien (TW)

(72) Inventors: Li-Sen CHEN, TAOYUAN HSIEN (TW); Yen-Jang LIAO, TAOYUAN HSIEN (TW); Pei-Lei TU, TAOYUAN HSIEN (US); Josue CASTILLO, TAOYUAN HSIEN (US); James Patrick YOUNG, TAOYUAN HSIEN (US)

(73) Assignee: SPEED TECH CORP., TAOYUAN HSIEN (TW)

(21) Appl. No.: 13/720,991

(22) Filed: Dec. 19, 2012

(30) Foreign Application Priority Data
Jul. 25, 2012 (TW) 101214460

(51) Int. Cl. H01R 12/16

(52) U.S. Cl. CPC H01R 23/68
USPC 439/629

(57) ABSTRACT

A card edge connector is provided, including an insulating body, a plurality of terminals and a pair of ear clips. The plurality of terminals and the ear clips are received and arranged in the insulating body. Each terminal comprises a fixed part, with a contact part formed by extending from one end of the fixed part, and a welding part formed by extending from another end of the fixed part. An extending part is arranged between the fixed part and the contact part, and at least one coupling protrusion is arranged outwards on the fixed part in a protruding way. The coupling protrusion is in interference fit with the insulating body, and the impedance value of each terminal is adjusted by changing the appearance and size of the coupling protrusion, where an optimal area of one of the coupling protrusions is 0.3 mm*0.7 mm.

### RELATED APPLICATIONS

This application claims priority to TW application Serial Number 101214460, filed Jul. 25, 2012, which is herein incorporated by reference.

### BACKGROUND

1. Field of Invention

The invention relates to a card edge connector. More particularly, the invention relates to a card edge connector applied to a memory card module, a display card module, a hard disk module or a WLAN card (wireless local area network card) module.

2. Description of Related Art

Card edge connectors applied to a memory card module, a network interface card module, a multi-media player module or a GPS (global position system) module and the like of a desktop computer, a notebook computer or other portable multi-media players are usually hard to conform to the standard specification of high frequency signals as signals interfere with each other due to a large number of terminals. In addition, as the terminals are miniaturized, the assembly of the card edge connector with an insulating body tends to be difficult in production.

As shown from FIG. 14 to FIG. 16, Taiwan Patent No. M421627 provides a card connector which includes an insulating body A10, a plurality of front terminals A21 and a plurality of back terminals A22. The insulating body A10 comprises a card receiving groove All for receiving an electronic card (not shown), and further includes a plurality of front terminal grooves A14 and a plurality of back terminal grooves A16. Each front terminal A21 is received in the front terminal groove A14. Each front terminal A21 comprises a first holding part A211, a first clamping part A212, a first elastic arm A213, a second elastic arm A214, a first welding parts A215 and a first contact part A216, wherein the first clamping part A212 is formed by extending upwards from the rear end of the first holding part A211, the first elastic arm A213 is formed by obliquely extending upwards and forwards from the middle of the front end of the first clamping part A212 and then bending and extending downwards, the second elastic arm A214 is formed by obliquely extending upwards from the middle of the first holding part A211 and then horizontally extending forwards, the first welding parts A215 are formed by extending downwards from the lower part of the front end of the first holding part A211, and the first contact part A216 is formed by protruding at the corresponding part of the front end of the first holding part A211 and the tail end of the second elastic arm A214.

Furthermore, each of the back terminal A22 has a second holding part A221 extending vertically as a strip, a third elastic arm A223 formed by extending upwards from the second holding part A221 and then horizontally extending forwards and further bending and extending downwards, a second clamping part A222 formed by extending forwards from the bottom of the third elastic arm A223 which disposed on the top of the second holding part A221, a clamping part A224 formed by extending forwards from the bottom of the second holding part A221, and a second welding part A225 formed by bending and extending backwards from the bottom of the second holding part A221. The first holding part A211 is held in the first receiving cavity A14 The first clamping part A212 is held in the first holding cavity A142. An end of the first elastic arm A213 is inserted in the card receiving groove A11. The second elastic arm A214 and the first contact part A216 are received in the first receiving cavity A141. The second holding part A221 is held in the second holding cavity A162. The second clamping part A222 is held in the second holding cavity A162. An end of the third elastic arm A223 is inserted into the card receiving groove A11. The first welding part A215 is exposed of the front terminal groove A14 in a staggered way for convenient to welding. The second welding part A225 is exposed of the back terminal groove A16, in which the first elastic arm A213 can be pressed to touch the second elastic arm A214.

However, in the above-mentioned terminal structure, since each front terminal and each back terminal are respectively formed in a way of taking the first holding part and the second holding part as main bodies and taking other elements as branches, when the terminals provide electronic signals for transfer, sections passing through the first holding part and the second holding part result in sudden increase of current energy due to multiple branches, so as to reduce the high frequency impedance value of each element, and mutual interference is generated and results in weakening of signals; furthermore, as extra branch elements exist, in volume production processing, when the terminal is assembled on the insulating body, factors of terminal breakage, deformation, or scraping tend to take place, and the possibility of defective products produced by automatic equipment in processing is increased, thus causing issues that need to be solved in production.

### SUMMARY

The invention provides a card edge connector. In this card edge connector, a terminal structure is designed simply, and the impedance value of the terminal is adjusted by changing the appearance and size of a coupling protrusion, so as to improve the signal completeness of transfer of high frequency signals among card edge connectors.

The card edge connector disclosed by the invention mainly consists of an insulating body, a plurality of terminals and a pair of ear clips. A long slot and a plurality of insertion slots are concavely formed in the middle of the insulating body. The long slot runs through the insertion slots. An electronic card can be inserted and positioned in the long slot. The terminals are respectively fixed in the insertion slots. The ear clips are respectively received and arranged in a receiving groove of the insulating body; and the ear clips are arranged in the receiving groove of the insulating body in a loose fit manner. The plurality of terminals respectively includes a fixed part, with a contact part formed by extending from one end of the fixed part, and a welding part formed by extending from another end of the fixed part. An extending part is arranged between the fixed part and the contact part. The fixed part comprises at least one coupling protrusion in a protruding manner. The coupling protrusion interferes with the insertion slots, so that the terminal is closely matched with the insulating body, and they are not likely to get separated or fallen off. Furthermore, as the impedance value of each terminal is adjusted by changing the appearance and size of a coupling protrusion, the optimal area of one of the coupling protrusions is 0.3 mm*0.7 mm.

The plurality of terminals of the invention are classified into first terminals and second terminals. The first terminals are assembled in the insertion slots from the bottom of the insulating body; and the second terminals are assembled in the insertion slots from the side surface of the insulating body, wherein proper spaces are kept between the insertion slots. The insertion slots for assembling the first terminals and the insertion slots for assembling the second terminals are arranged in a staggered way, so that the contact parts of the first terminals and the contact parts of the second terminals are partially received in the long slot in a mutually symmetric way, so as to be favorable for the electric connection of the electronic card with the plurality of terminals.

The area of the coupling protrusion of the second terminals of the invention is 0.3 mm*0.7 mm, so that the impedance value of the terminal may reach the standard specification of 75-95 ohms of high frequency impedance.

Two guide surfaces are respectively arranged between the fixed part and the welding part of the first terminal and between the fixed part and the extending part of the second terminal. The guide surfaces can guide all the terminals to enter all the insertion slots, so as to assist the interference fit between the coupling protrusion and the insulating body. In addition, the fixed part and the welding part are located in different longitudinal planes, so that the welding part keeps parallel to an opposite circuit board to form an electric connection. The extending part of the first terminal obliquely bends and extends upwards, so as to form a transformation space for elastic bending, thereby being favorable for elastic positioning when the electronic card is inserted.

Other applications of the invention are apparent according to the disclosure of the invention, however, the disclosure of the invention is realized in a way that the impedance value of the terminal is adjusted by changing the appearance and size of a coupling protrusion, so as to reach the required scope of impedance of high frequency electronic signals; furthermore, as there are no extra elements arranged for the terminals, the terminals can be accurately assembled on the insulating body by utilizing automation equipment, thereby effectively improving the entire yield of mass production. The design manners of those skilled in the art by utilizing other similar principles still fall within the scope disclosed by the invention.

### BRIEF DESCRIPTION OF THE DRAWINGS

FIG. 1 is an oblique view of a first view angle of the invention;

FIG. 2 is an oblique view of another view angle of the invention;

FIG. 3 is an explosive view of the first view angle of the invention;

FIG. 4 is an explosive view of the second view angle of the invention;

FIG. 5 is an explosive view of a third view angle of the invention;

FIG. 6 is an appearance schematic view of a first terminal of the invention;

FIG. 7 is an appearance schematic view of a second terminal of he invention;

FIG. 8 is a front view of an embodiment of the invention after assembly;

FIG. 9 is an A-A profile map of an embodiment of the invention;

FIG. 10 is a computer simulation diagram of the high frequency impedance value of an original terminal when the area of the coupling protrusion is 1.2 mm*0.5 mm;

FIG. 11 is a computer simulation diagram of the high frequency impedance value of a second terminal of the invention when the area of the coupling protrusion is 0.3 mm*0.7 mm;

FIG. 12 is a computer simulation diagram of the high frequency impedance value of the original terminal;

FIG. 13 is a computer simulation diagram of the high frequency impedance value of the first terminal of the invention;

FIG. 14 is an explosive view of Taiwan Patent No. M421627;

FIG. 15 is a profile map of Taiwan Patent No. M421627; and

FIG. 16 is a lateral view profile map of Taiwan Patent No. M421627.

### DETAILED DESCRIPTION

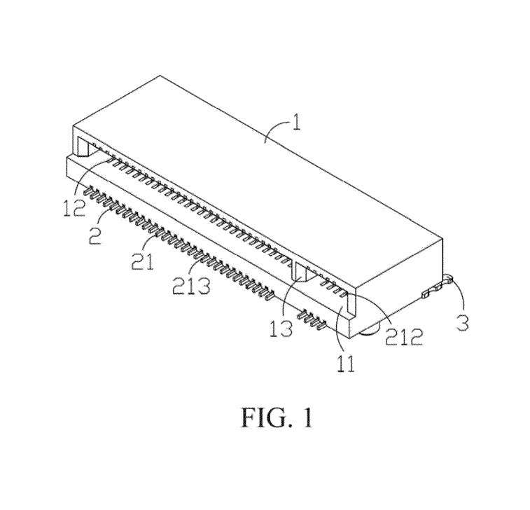

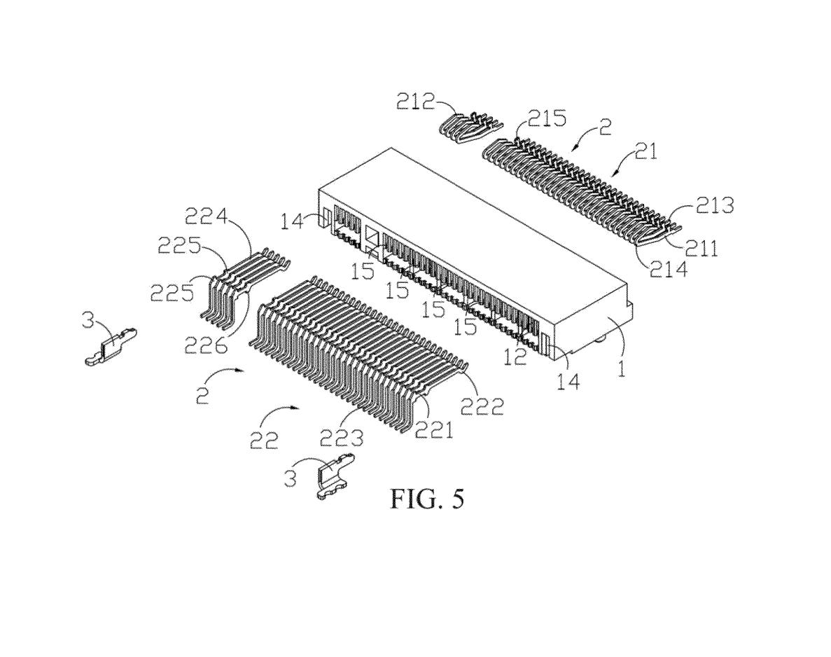

As shown in FIG. 1, in an embodiment of the invention, the card edge connector mainly consists of an insulating body 1, a plurality of terminals 2 and a pair of ear clips 3. A long slot 11 and a plurality of insertion slots 12 are concavely formed in the middle of the insulating body 1. The long slot 11 runs through the insertion slots 12. An electronic card (not shown) such as a memory card, a display card, a sound card or a wireless local area network (WLAN) card can be inserted and positioned in the long slot 11. The long slot 11 can be additionally include a positioning column 13 according to the position of a positioning bayonet of the corresponding electronic card (not shown). The positioning column 13 is normally located at the non-center position of the long slot 11 According to the embodiment, the main principle is to design one positioning column 13, of course, two or more positioning columns 13 can be designed to meet with the need of the corresponding card. The positioning column 13 is correspondingly arranged according to a reverse-insertion-prevention device of the electronic card (not shown), that is, the burnout of the electronic card (not shown) caused by mis-installation of the electronic card (not shown) in the long slot 11 is prevented, and the use safety of the electronic card (not shown) is improved. In addition, referring to FIG. 5, the terminals 2 are respectively fixed in the insertion slots 12; two sides of the insulating body 1 respectively includes a receiving groove 14; and the ear clips 3 are arranged in the receiving groove 14 in a loose fit manner.

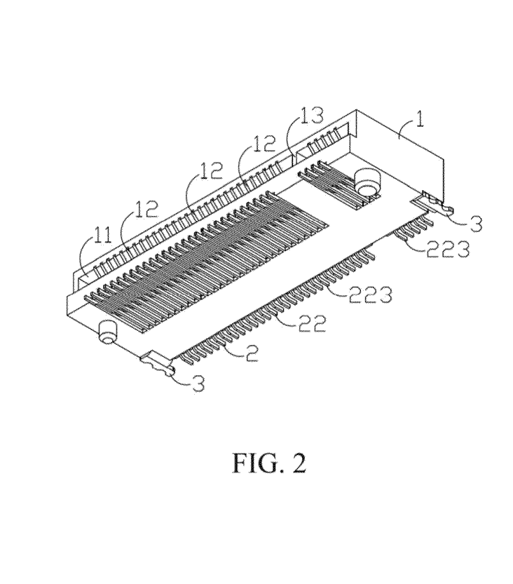

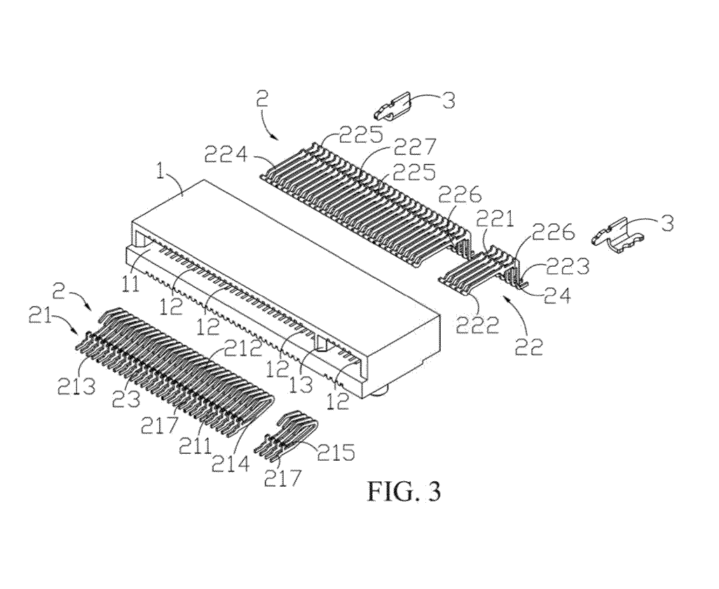

As shown in FIGS. 2 and 3, in an embodiment of the invention, the plurality of terminals 2 are directly punched by a metal sheet to form a flake structure, and the insulating body 1 can be assembled by utilizing automation equipment without processing or bending additionally. The plurality of terminals 2 respectively includes fixed parts 211 and 221, with contact parts 212 and 222 formed by extending respectively from one end of the fixed parts 211 and 221, and welding parts 213 and 223 formed by extending respectively from another end of the fixed parts 211 and 221. Extending parts 214 and 224 are arranged between the fixed parts 211 and 221 and the contact parts 212 and 222. At least one coupling protrusion 215 and at least one coupling protrusion 225 are arranged by protruding outwards vertically from the fixed parts 211 and 221. The coupling protrusions 215 and 225 are in interference fit with the insertion slots 12 via external force, so that the terminal 2 is restricted and positioned in the insulating body 1, Since the terminal 2 is in close fit with the insulating body 1 in a mutually forcible interference manner, and they are not likely to get separated or fallen off. Furthermore, the impedance value of each terminal 2 is adjusted by changing the appearance and size of the coupling protrusions 215 and 225, and the optimal area of one coupling protrusion 225 in the invention is 0.3 mm*0.7 mm.

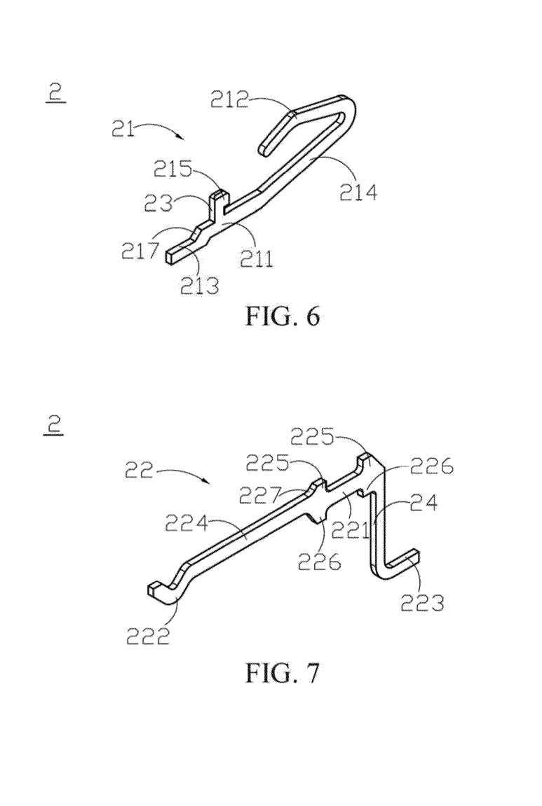

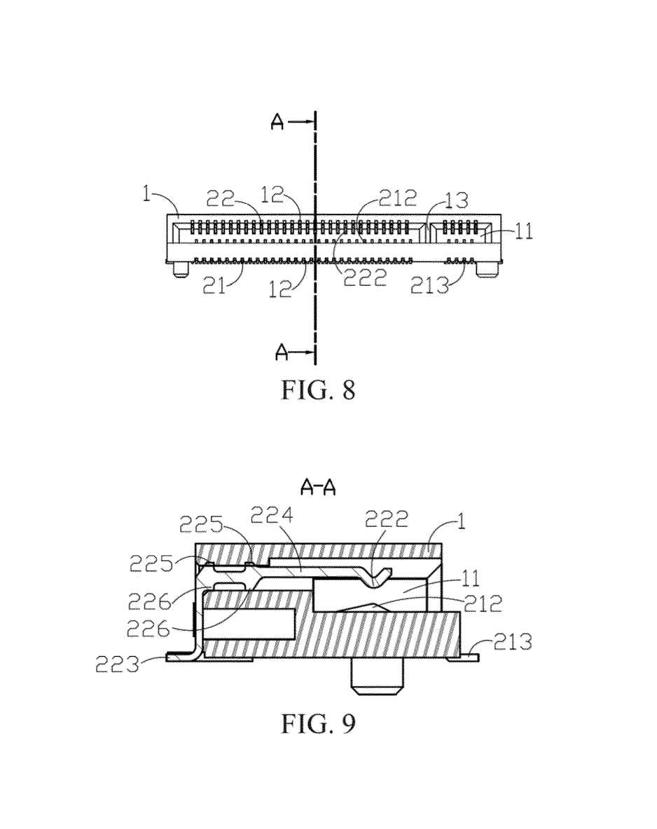

As shown in FIGS. 6-9, in an embodiment of the invention, the plurality of terminals 2 are classified into first terminals 21 and second terminals 22. The first terminals 21 are upwardly assembled in the insertion slots 12 from the bottom of the insulating body 1. The first terminal 21 comprises a platy terminal body. The extending part 214 of the first terminal 21 obliquely bends and extends upwards and accurately forms a 180-degree curve, so that when the electronic card (not shown) is assembled in the insulating body 1, the first terminal 21 has a transformation space for elastic bending so as to assist the assembly and positioning of the electronic card (not shown). The second terminal 22 is assembled in the insertion slot 12 inwards from the side surface of the insulating body 1. The second terminal 22 comprises a platy terminal body. The welding part 223 of the second terminal 22 is L-shaped, so as to be convenient for electric connection with the circuit board (not shown). The second terminal 22 comprises the coupling protrusions 225 respectively at two sides of the fixed part 221. Since the second terminal 22 at least has two coupling protrusions 225, when the electronic card (not shown) is assembled on the insulating body 1, the interference fit between the second terminal 22 and the insertion slot 12 can be enhanced, so that the second terminal 22 is not likely to get separated or deformed. In addition, another sides opposite to the coupling protrusions 225 of the second terminals 22 respectively has a base part 226. The bottom of the base part 226 is taken as a reference plane to lean against the insertion slot 12 and push inwards in parallel, so as to assist the automation equipment to smoothly push the second terminal 22 to accurately enter the corresponding insertion slot 12 in mass production. A proper interval is reserved between the insertion slots 12. The insertion slots 12 for assembling the first terminals 21 and the insertion slots 12 for assembling the second terminals 22 are arranged transversely in a mutually staggered way, so that the contact parts 212 of the first terminals 21 and the contact parts 222 of the second terminals 22 are partially received in the long slot 11 in a mutually symmetric way, thereby being favorable for the electric connection between the electronic card (not shown) and the plurality of terminals 2, and further conducting the electronic card (not shown) and the circuit board (not shown), and realizing unidirectional or bidirectional transmission of data between the electronic card and the circuit board.

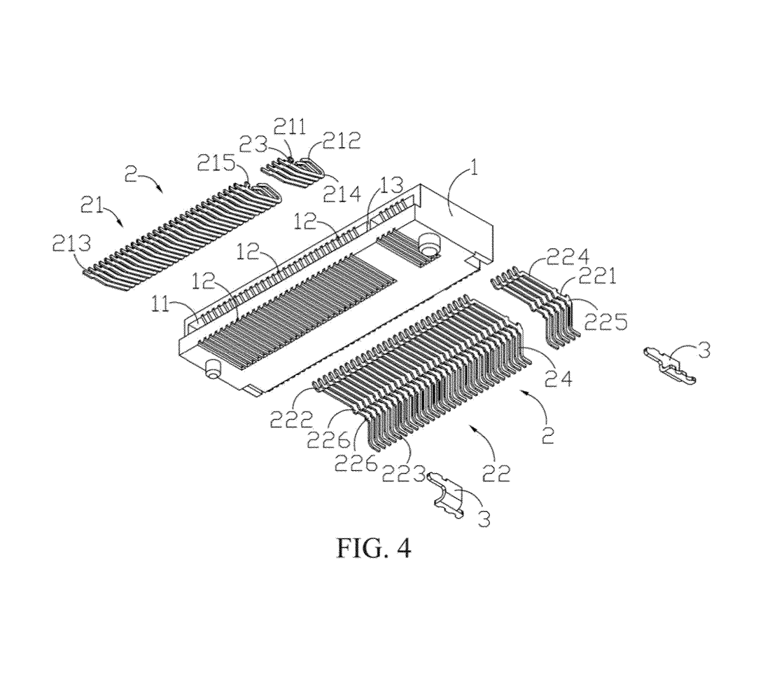

As shown in FIGS. 3-5, in an embodiment of the invention, guide surfaces 217 and 227 are respectively arranged between the fixed part 211 and the welding part 213 of the first terminal 21 and between the fixed part 221 and the extending part 224 of the second terminal 22. The guide surfaces 217 and 227 can guide all the terminals 2 to enter the insertion slots 12. The planes of the coupling protrusions 215 of the first terminal 21 and the welding part 223 of the second terminal 22, towards the same direction with the guide surfaces 217 and 227, respectively has a first stop part 23 and a second stop part 24. The first terminal 21 takes the first stop part 23 as a reference plane and pushes upwards via an external force by taking the reference plane as a center; and the second terminal 22 pushes inwards via an external force, so that the guide surfaces 227 guides the coupling protrusion 225 accordingly and the second stop part 24 is utilized as a push stop point to enable the second stop part 24 to stop going ahead after leaning against an outer wall 15 of the insertion slot 12, and thus both of the coupling protrusions 215 and 225 are assisted to form interference fit with the insulating body 1 respectively. In addition, the fixed parts 211 and 221 and the welding parts 213 and 223 are located in different longitudinal planes, and the welding parts 213 and 223 keep parallel to a corresponding circuit board (not shown) to form an electric connection, thereby facilitating the welding operation by adopting a production manner with SMT (Surface Mounting Technology) without placing a pin of the terminal 2 in a drill hole of the circuit board (not shown).

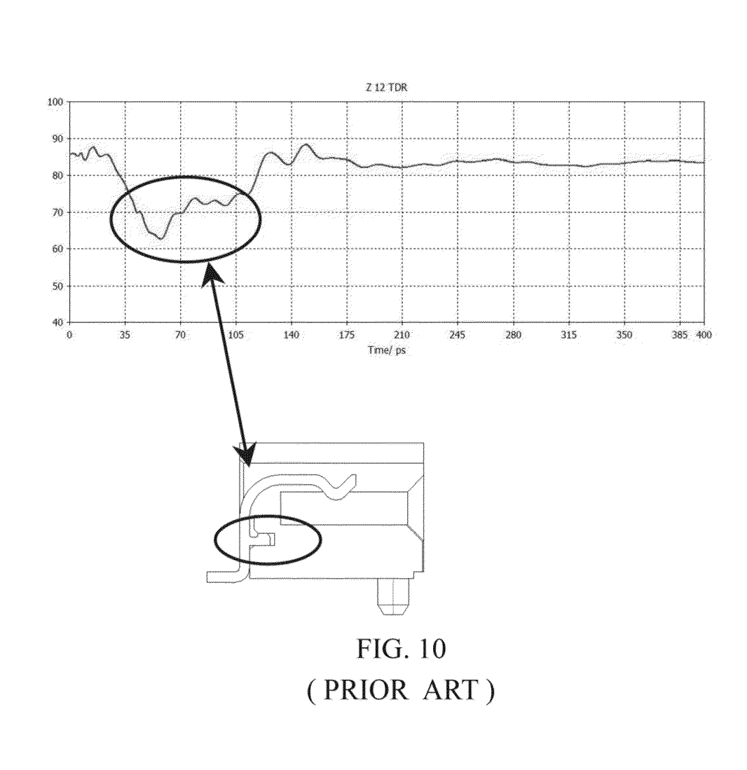

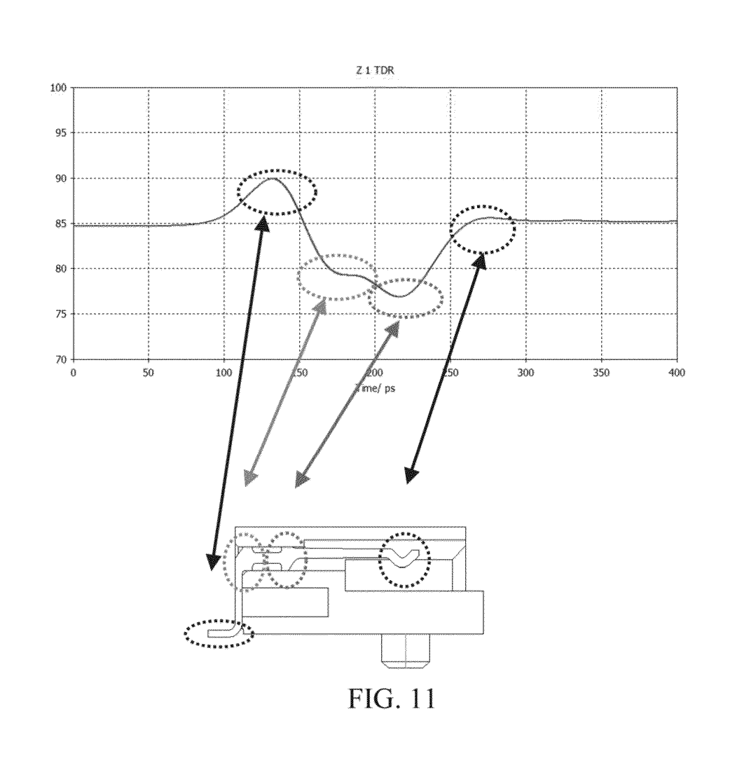

As described above, the standard value of common high frequency impedance is 75-95 ohms. As shown in FIG. 10, the area of the coupling protrusion of the original terminal is 1.2 mm*0.5 mm; and the high frequency impedance value simulation by a computer is less than 75 ohms and cannot reach the requirement of the standard specification of high frequency impedance. As shown n FIG. 11, in an embodiment of the invention, the area of the coupling protrusion 225 of the second terminal 22 is 0.3 mm*0.7 mm, so that the impedance value of the terminal can reach the standard specification of high frequency impedance, that is 75-95 ohms.

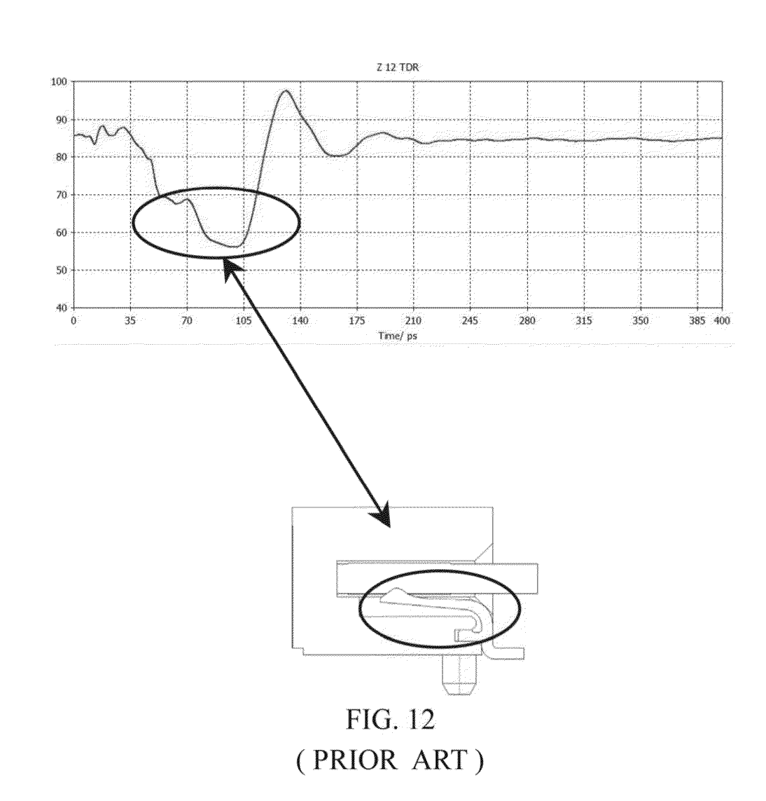

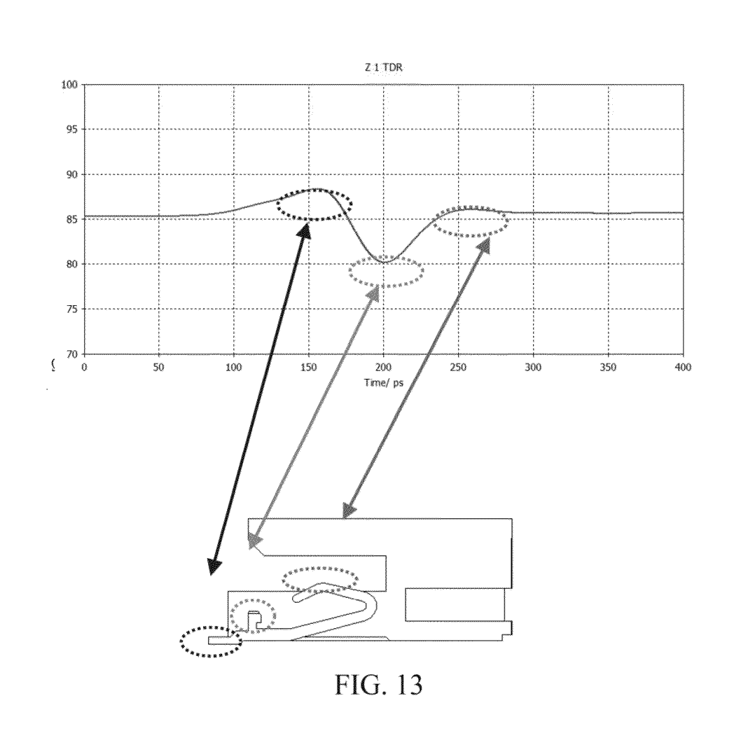

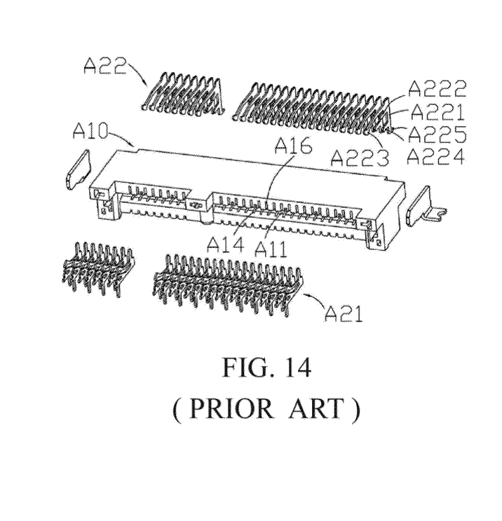

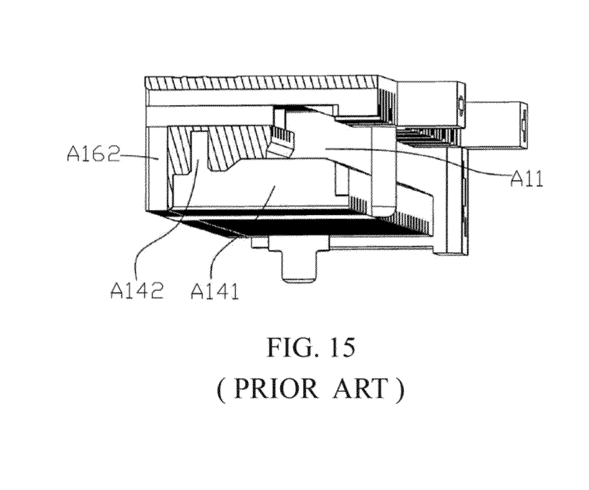

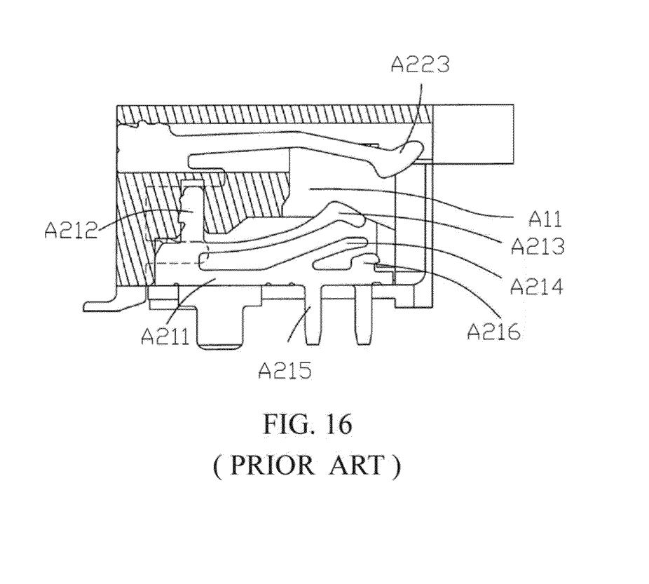

As described above, capacitance exists between any two metals that are not conducted to each other, that is, the capacitance effect. As shown in FIG. 12, since the original terminal is too close to the circuit board, the capacitance effect between the contact point (Pad) of the electronic card and the original terminal tends to increase, and the high frequency impedance value simulation by a computer is less than 75 ohms and cannot reach the requirement of the standard specification. As shown in FIG. 13, in an embodiment of the invention, the impedance value of the first terminal 21 can reach the standard specification of the high frequency impedance, that is, 75-95 ohms by changing the appearance and size of the coupling protrusion 215.

Although the invention has been disclosed with reference to the above embodiments, these embodiments are not intended to limit the invention. It will be apparent to those skilled in the art that various modifications and variations can be made without departing from the scope or spirit of the invention. Therefore, the scope of the invention shall be defined by the appended claims.

What is claimed is:

1. A card edge connector comprising:
an insulating body;
a plurality of terminals received and arranged in the insulating body, wherein each terminal comprises:
a fixed part comprising;
a contact part extended from one end of the fixed part;
a welding part extended from another end of the fixed part;
an extending part arranged between the fixed part and the contact part; and
at least one coupling protrusion protruded from the fixed part, wherein each coupling protrusion interferes with the insulating body, and the impedance value of each terminal is adjusted by changing the appearance and size of the coupling protrusion, wherein an optimal area of the coupling protrusion is 0.3 mm*0.7 mm.

2. The card edge connector of claim 1, wherein a long slot and a plurality of insertion slots are concavely formed in the middle of the insulating body, the long slot runs through the insertion slots, an electronic card is inserted and positioned in the long slot, and the terminals are respectively fixed in the insertion slots.

3. The card edge connector of claim 2, wherein the plurality of terminals are classified into a plurality of first terminals and a plurality of second terminals, the first terminals are assembled in the insertion slots from the bottom of the insulating body, and the second terminals are assembled in the insertion slots from the side surface of the insulating body.

4. The card edge connector of claim 3, wherein two guide surfaces are respectively arranged between the fixed part and the welding part of the first terminal and between the fixed part and the extending part of the second terminal, and the guide surfaces guide all the terminals to enter the insertion slots, so as to further assist the coupling protrusion to interfere with the insulating body.

5. The card edge connector of claim 1, wherein the fixed part and the welding part are located on different longitudinal planes.

6. The card edge connector of claim 3, wherein the extending part of the first terminal obliquely bends and extends upwards, so as to form a transformation space for being elastically inserted by the electronic card.

7. The card edge connector of claim 1, wherein the card edge connector further comprises a pair of ear clips, and the ear clips are respectively arranged in a receiving groove of the insulating body in a loose fit manner.

8. The card edge connector of claim 3, wherein the area of the coupling protrusion of the second terminal is 0.3 mm*0.7 mm.
